(19) United States
(12) Patent Application Publication
(10) Pub. No.: US 2003/0042693 A1
(43) Pub. Date: Mar. 6, 2003

(54) Walking snowboard

(76) Inventor: Lyle J. Christiansen, Morris, MN (US)

Correspondence Address: Lyle J. Christiansen, 701 Imperial Drive, Morris, MN, 56267, US

(21) Appl. No.: 09/942,159

(22) Filed: Aug. 28, 2001

(51) Int. Cl. B62B 15/00; A63C 17/18; B62M 27/00

(52) U.S. Cl. 280/8; 280/7.14; 280/14.21; 280/21.1

(57) ABSTRACT

A walking snowboard that enables its user to walk over snow cross-country and also to surf down slopes.

A shared floating-tongue (20) comprising vinyl rollers and wheels is located in and along over half the length of framed chambers beneath a deck (10). The snowboard with its split body rolls easily over the shared floating-tongue as a user walks. The shared floating-tongue interconnects with the two sides of the walking snowboard's body.

### CROSS-REFERENCE TO RELATED APPLICATIONS

Not applicable

### BACKGROUND—FIELD OF THE INVENTION

This invention relates to snowboards specifically to such snowboards that are used for both walking cross-country and for downhill snowsurfing.

### BACKGROUND—DESCRIPTION OF PRIOR ART

Many different snowboards have recently been introduced that are of different shapes and different construction and are built from lightweight materials. Snowboards enthusiasts have welcomed these new developments.

One drawback of snowboards now in use is that they are only for use in surfing down slopes. What is needed is a snowboard that one can walk cross-country with.

One type of snowboard/snowshoe has been proposed. In U.S. Pat. No. 5,884,933 to Trott (1999) shows a pair of snowshoes that are used for cross-country and also are used for snowboarding downhill by connecting the two snowshoes together by a bracket. This bracket has to be carried separately along until one is at the top of a hill and then is connected to the snowshoes. When using the snowshoes for cross-country a person puts all ones weight on first one snowshoe, then all of ones weight on the other snowshoe which causes one to sink deeply into the soft snow with each awkwardly step. One has to swing ones legs outwardly with each step to prevent one snowshoe from pinning the other snowshoe as this is what would happen if one snowshoe came down on the other as one walked.

A ski shoe proposed by McManus U.S. Pat. No. 5,553,403 (1996) relates to a combination of skis and snowshoes for either walking in snow of sliding down slopes. But it is wide like most other snowshoes and one has to swing one's legs outwardly and awkwardly when walking with them and ones weight is first all on one ski shoe and then on the other ski shoe causing the ski shoes to sink deeply into soft snow.

### OBJECTS AND ADVANTAGES

Accordingly, besides the objects and advantages of walking snowboards of the present invention are:

To provide a snowboard which can be used for downhill snowsurfing as well as cross-country walking.

### DRAWING FIGURES

FIG. 1 shows a walking snowboard with its boot clamps and back plates.

FIG. 2 shows a view of the walking snowboard from the back and partially underneath.

FIG. 3 shows a perspective (side and front view) of a walking snowboard's shared floating tongue with its vinyl wheels and rollers.

### REFERENCE NUMERALS IN DRAWINGS

8 back plates (recessed)

10 deck on snowboard's split body

12 space between the two snowboard body sides

14 boot clamps

16 upward curvature

18 chamber frame

20 shared floating-tongue

22 vinyl rollers (vertical)

24 vinyl wheel

26 recess for back plate

28 bottom of walking snowboard

30 full length slot in tongue's chamber's central sides

=notch (one of 8)

34 roller bracket

36 rubber bumper

38 fixed axle

40 cutout (one of 4)

### SUMMARY

In accordance with the present invention, two length of snowboard are slidingly connected side-by-side. Each half of the snowboard comprising a boot clamp, therefore, enabling a user to walk over the snow and also to surf down slopes.

### OBJECTS AND ADVANTAGES

Accordingly, besides the objects and advantages of walking snowboards of the present invention, are:

to provide a snowboard which can be used for downhill snow surfing as well as cross-country walking.

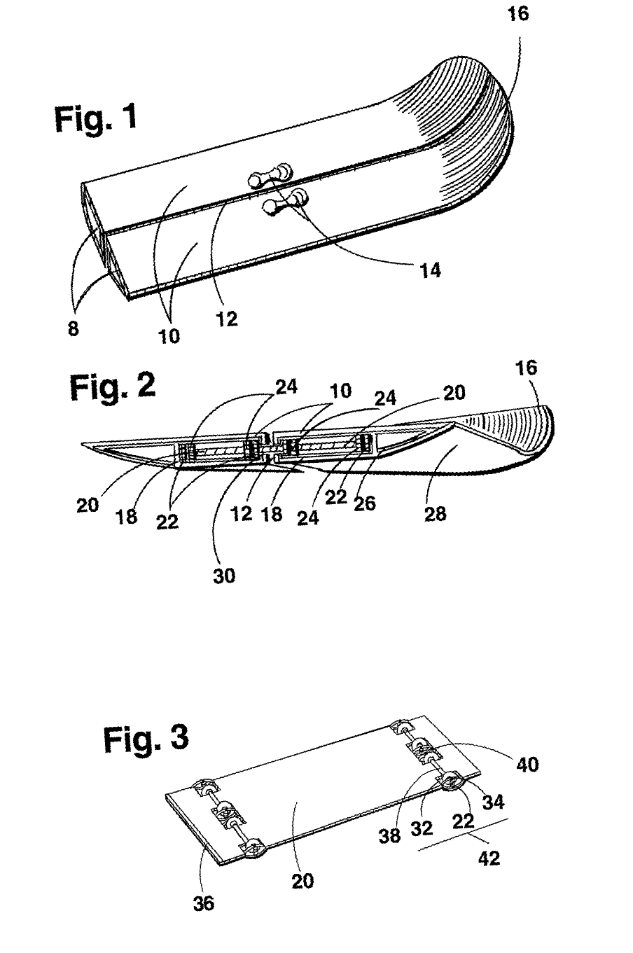

### DESCRIPTION—FIGS 1-3—PREFERRED EMBODIMENT

A preferred embodiment of a walking snowboard is illustrated in FIG. 1 (perspective view) a walking snowboard with its split body deck 10 is shown side by side with a space 12 between them. Boot clamps 14 are shown a natural distance apart and midway of the snowboard's length. They are a type that holds the snowboard to one's boots securely, yet allows the snowboard to fall away when one tumbles to prevent injuries the front ends of the snowboard's deck have an upward curvature 16, two back plates 8 one for each side of said snowboard's split body fit flush inside the back end's of each snowboard's split body sides.

In FIG. 2, a shared floating-tongue 20 extends over halfway inside two full-length chamber frames 18. A full-length slot 30 in the chamber's central sides allows this. Vinyl rollers (vertical) 22 are located in roller brackets 34 which are attached to the tongue at notches 32 and at central locations of cutouts 40. Vinyl wheels 24 turn on fixed axles 38 and are located in the notches and cutouts. A recess 26 extends around and inside the perimeter of the two back ends of the split deck. The bottom of the snowboard 28 is flat along the width of the tongue's chambers then curves upward for the rest of the snowboard's width in FIG. 2. A rubber bumper 36 is attached to the rear end of the tongue for its full width.

ADDITIONAL EMBODIMENTS

A rudder could be added and push poles with rudder controls on their handles could be added for use on steeper slopes to give one steering control and stability for the snow surfer. The push poles would be strongly anchored to the walking snowboard at a convenient location just in front of the snow surfer.

ALTERNATIVE EMBODIMENTS

Instead of a shared floating-tongue with rollers and wheels a shared solid vinyl tongue and vinyl walls of the chamber box would be simpler to manufacture and would satisfy many in general use although it would not operate as smoothly as the current walking snowboard.

ADVANTAGES

From the description above, an advantage of my walking snowboard becomes evident.

(a) The walking snowboard operates for cross-country use plus use when surfing down slopes.

OPERATION—FIGS. 1-3

The manner of using the walking snowboard is:

(a) take them to a location where there is a good snow cover;

(b) step into the boot clamps 14 on the snowboard and tighten the straps;

(c) begin walking across the top of the snow using a shuffle, straight ahead natural walk;

(d) when reaching a down slope, bend forward in a typical skier's position and surf down the slope. To make turns, spring your body and the snowboard into the air, twist left, or right, landing back on the snow and heading in the direction you want to go.

The walking snowboard's deck of the snowboard's body 10 FIG. 1 is uncluttered except for boot clamps 14 which are similar to ski bindings. There is a space 12 down the center of the deck. The fronts of the two halves of the deck have an upward curvature 16 to guide the snowboard over banks of snow. Each side of the split snowboard's body has a back plate that is recessed 26 and which is attached to the snowboard with screws making each side of the split snowboard's body a rigid unit.

FIG. 3 shows a shared floating-tongue 20 that is over half the length of the chamber and consists of vinyl rollers (vertical) 22 attached to it. Roller brackets 34 are arch shaped with the rollers attached vertically between them and are located in cutouts 40 and notches 32 on the tongue. The tongue is located inside two chamber frames 18 located under the deck of the snowboard. The vinyl rollers enable the tongue to move forward easily and without binding sideways. The tongue also has multiple vinyl wheels 24 located in the notches and in cutouts on the tongue. These vinyl wheels enable the tongue to move forward easily and without binding upwards or downwards. The back plates push the tongue forward alternatively when one walks with the walking snowboard. A rubber bumper 36 attached to the back end of the shared floating-tongue stops the noise when a back plate strikes it when one-steps forward. A full-length slot 30 in the tongue chamber's frame upper sides enables the tongue to slide forwards in the tongue's chambers. Multiple fixed axles 38 attached to locations on the tongue have vinyl wheels located at their ends.

The bottom of the snowboard 28 is flat under the tongue's chamber frames and curves upwards the rest of the way until it meets the flat plane of the deck.

CONCLUSION, RAMIFICATIONS, AND SCOPE

Accordingly, the reader will see that the walking snowboard can be used to walk over the top of deep snow without sinking in deep.

They also permit the user to surf down slopes

They are sleek and pleasing in appearance. The upper and lower surfaces are unobstructive and mainly plane. An upward curvature on their fronts enables them to travel up and over banks of snow.

The walking snowboard is constructed of a lightweight, strong material such as aluminum or they could be molded using a strong plastic resin material.

Although the description above contains many specifics, these should not be construed as limiting the scope of the invention but as merely providing illustrations of some of the presently preferred embodiments of this invention. For example, ski poles could be used with the walking snowboard to maintain the user's balance.

Thus the scope of the invention should be determined by the appended claims and their legal equivalents, rather than by the examples given.

I claim:

1. A snowboard with a split body comprising a shared floating-tongue with vinyl rollers and wheels thereon which interconnects one side of said split body with the other side of the split body, and framed chambers beneath the deck of said snowboard that receives the said shared floating-tongue.

2. The framed chambers of claim 1 wherein comprise slots in their side uprights for their full length and said slots receive the body of the shared floating-tongue which is over half the length of the framed chambers.

3. The shared floating-tongue of claim 1 comprises vinyl rollers that are vertically located in roller brackets that are located across notches that are around the perimeter of the tongue and also are located across cutouts down the center of the tongue in a double line.

4. The shared floating-tongue of claim 1 wherein comprises multiple vinyl wheels which are located in notches and in cutouts of the tongue and said vinyl wheels turn on axles that are fixed on the body of the tongue.

5. The shared floating-tongue of claim 1 wherein comprises a rubber bumper on its end that's at the rear of the tongue.

6. The snowboard of claim 1 wherein comprise back plates which are securely attached and located on the back ends of the snowboard's split body.

7. The snowboard of claim 1 wherein comprise front ends that have a pronounced upward curvature.

8. The deck of claim 1 wherein comprise boot clamps located on the deck at a position that's naturally comfortable for walking and approximately midway of the snowboard's length.
